(19) United States
(12) Patent Application Publication
(10) Pub. No.: US 2020/0204392 A1
(43) Pub. Date: Jun. 25, 2020

(54) HOME APPLIANCE CONTROL SYSTEM

(71) Applicant: MING-TSUNG CHEN, Taipei City (TW)

(72) Inventors: MING-TSUNG CHEN, Taipei City (TW); SZU-MEI SUN, Taoyuan City (TW)

(21) Appl. No.: 16/227,568

(22) Filed: Dec. 20, 2018

(51) Int. Cl. H04L 12/28; G08C 23/04

(52) U.S. Cl. CPC H04L 12/2816; G08C 17/02; H04L 2012/2841; G08C 23/04

(57) ABSTRACT

A home appliance control system is provided, which includes: a first home appliance, a second home appliance, a first control device, and a second control device. The first control device is disposed on the first home appliance, and configured to convert a plurality of Bluetooth control signals received by a first Bluetooth communication module to infrared control signals of a first infrared communication module. The second control device is disposed on the second home appliance, and configured to convert a plurality of Bluetooth control signals received by a second Bluetooth communication module to infrared control signals of a second infrared communication module, where the second infrared communication module is configured to send the infrared control signals to a second infrared home appliance control module of the second home appliance by using a second infrared communication protocol.

### FIELD OF THE DISCLOSURE

The present disclosure relates to a home appliance control system, and more particularly to a home appliance control system that can be controlled by infrared rays even when being shielded by obstructions.

### BACKGROUND OF THE DISCLOSURE

In recent years, the concept of smart home has become more and more popular. Many home appliances have networking functions, and so that users can directly control them through network signals. However, in many families, there are still a large number of home appliances that do not have networking functions. Moreover, while the functions of those home appliances is are still remarkable, and. Moreover, many traditional home appliances have infrared remote control functions, but infrared rays are easily shielded from shielded by obstructions, which is not conducive to controlling anytime and anywhere.

Accordingly, it has become an important issue in the industry to provide a home appliance control system that can be controlled by infrared rays even when being shielded by obstructions.

### SUMMARY OF THE DISCLOSURE

The present disclosure provides a home appliance control system including: a first control device and a second control device. The first control device is disposed on a first home appliance including a first infrared home appliance control module having a first infrared communication protocol. The second control device is disposed on a second home appliance including a second infrared home appliance control module having a second infrared communication protocol. The first control device includes: a first Bluetooth communication module configured to receive a plurality of Bluetooth control signals; a first infrared communication module configured to send a plurality of infrared control signals; and a first control module electrically connected to the first Bluetooth communication module and the first infrared communication module, and configured to convert the plurality of Bluetooth control signals received by the first Bluetooth communication module to the infrared control signals of the first infrared communication module. The first infrared communication module is configured to send the infrared control signals to the first infrared home appliance control module of the first home appliance by using the first infrared communication protocol. The second control device includes: a second Bluetooth communication module configured to receive a plurality of Bluetooth control signals; a second infrared communication module configured to send a plurality of infrared control signals; and a second control module electrically connected to the second Bluetooth communication module and the second infrared communication module, and configured to convert the plurality of Bluetooth control signals received by the second Bluetooth communication module to the infrared control signals of the second infrared communication module. The second infrared communication module is configured to send the infrared control signals to a second infrared home appliance control module of the second home appliance by using a second infrared communication protocol.

The home appliance control system further includes: a mobile control device; and a server. The mobile control device communicates to the server and is configured to send a plurality of home appliance control signals of the first home appliance or the second home appliance.

The mobile control device includes a smart phone, a mobile tablet, and a smart watch.

The first infrared home appliance control module is disposed within a first signal transmission range of the first infrared communication module of the first control device, and the second infrared home appliance control module is disposed within a second signal transmission range of the second infrared communication module of the second control device.

The first control device further includes a first power supply module, and the second control device further includes a second power supply module.

The first power supply module and the second power supply module include a button battery, a lithium battery, an AC-to-DC voltage converter, or a DC-to-DC voltage converter respectively.

The mobile control device communicates with the first control device and the second control device by a Bluetooth communication protocol 4.0 or a Bluetooth communication protocol 5.0.

The first Bluetooth communication module and the second Bluetooth communication module are a low power Bluetooth communication module.

In summary, in the present disclosure, with a control device, which combines an infrared transmission function and a Bluetooth communication function, disposed on each home appliance, the issue that the infrared transmission will be shielded by obstructions can be solved. Further, with the Bluetooth communication function, the home appliance can be controlled locally or outdoors, so that the installation cost can be significantly reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view showing a home appliance control system depicted in accordance with an exemplary embodiment of the present disclosure.

FIGS. 2A, 2B, and 2C are schematic views respectively showing a first control device, a second control device, and a third control device of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

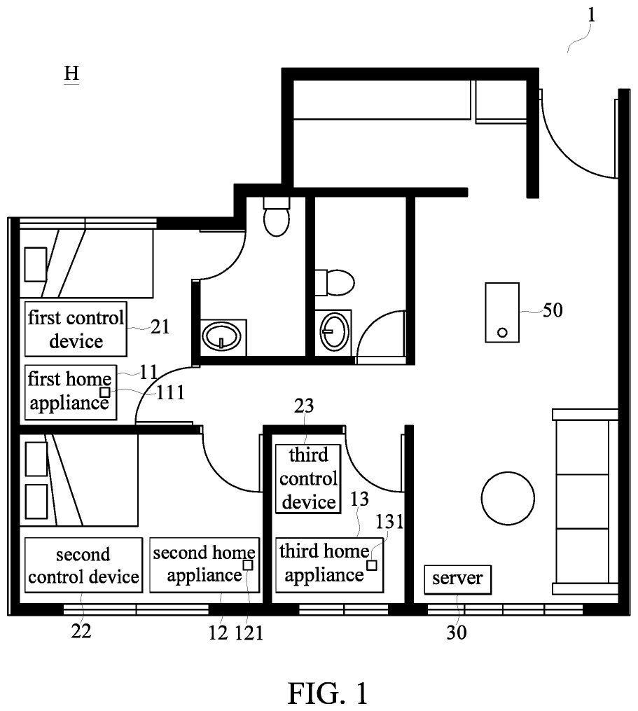

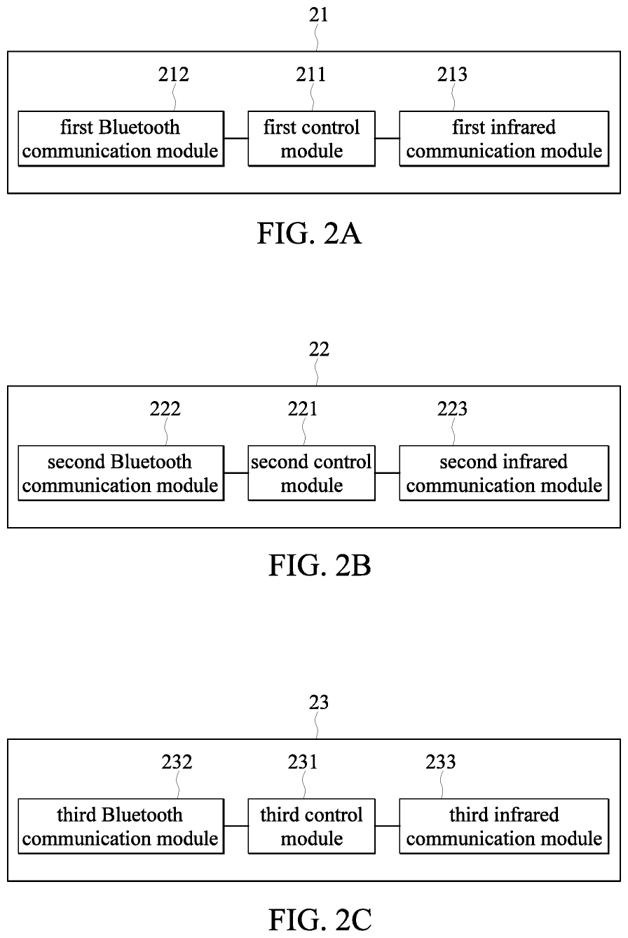

Reference is made to FIG. 1 and FIG. 2. FIG. 1 is a schematic view showing a home appliance control system depicted in accordance with an exemplary embodiment of the present disclosure. FIGS. 2A, 2B, and 2C are schematic views respectively showing a first control device, a second control device, and a third control device of FIG. 1.

A home appliance system 1 is disposed in a predefined area H. In the embodiment, the predefined area H is a home area. In other embodiments, the predefined area H includes various office areas, business areas, industrial areas, or other living areas, and the present disclosure is not limited therein.

The home appliance control system 1 includes a first home appliance 11, a second home appliance 12, a third home appliance 13, a first control device 21, a second control device 22, and a third control device 23.

The home appliance 1 further includes a mobile control device 50 and a server 30.

In the embodiment, the first home appliance 11 includes a first infrared home appliance control module (not shown in the drawings). The first infrared home appliance control module has a first infrared communication protocol. The second home appliance 12 includes a second infrared home appliance control module (not shown in the drawings) having a second infrared communication protocol. The third home appliance 13 includes a third infrared home appliance control module (not shown in the drawings) having a third infrared communication protocol.

In the embodiment, the first control device 21 is disposed on the first home appliance 11. The second control device 22 is disposed on the second home appliance 12. The third control device 23 is disposed on the third home appliance 13.

The first control device 21 is disposed on the first home appliance 11, and adjacent to a first infrared home appliance control module 111 of the first home appliance 11. In the embodiment, the first infrared home appliance control module 111 has a first infrared signal receiving terminal (not shown in the drawings) and a first signal receiving range. The first control device 21 is disposed within the first signal receiving range of the first infrared home appliance control module 111. The first control device 21 is required to be disposed adjacently to the first infrared signal receiving terminal (not shown in the drawings) to ensure that the first infrared signal receiving terminal (not shown in the drawings) of the first infrared home appliance control module 111 can receive a control signal transmitted by the first control device 21.

The second control device 22 is disposed on the second home appliance 12, and adjacent to a second infrared home appliance control module 121 of the second home appliance 12. In the embodiment, the second infrared home appliance control module 121 has a second infrared signal receiving terminal (not shown in the drawings) and a second signal receiving range. The second control device 22 is disposed within the second signal receiving range of the second infrared home appliance control module 121. The second control device 22 is required to be disposed adjacently to the second infrared signal receiving terminal (not shown in the drawings) to ensure that the second infrared signal receiving terminal (not shown in the drawings) of the second infrared home appliance control module 121 can receive a control signal transmitted by the second control device 22.

The third control device 23 is disposed on the third home appliance 13, and adjacent to a third infrared home appliance control module 131 of the third home appliance 13. In the embodiment, the third infrared home appliance control module 131 has a third infrared signal receiving terminal (not shown in the drawings) and a third signal receiving range. The third control device 23 is disposed within the third signal receiving range of the third infrared home appliance control module 131. The third control device 23 is required to be disposed adjacently to the third infrared signal receiving terminal (not shown in the drawings) to ensure that the third infrared signal receiving terminal (not shown in the drawings) of the third infrared home appliance control module 131 can receive a control signal transmitted by the third control device 23.

In the embodiment, the first control device 21 includes a first control module 211, a first Bluetooth communication module 212, and a first infrared communication module 213.

The first Bluetooth communication module 212 is configured to receive a plurality of Bluetooth control signals. The first infrared communication module 213 is configured to send a plurality of infrared control signals. The first control module 211 is electrically connected to the first Bluetooth communication module 212 and the first infrared communication module 213. The first control module 211 is configured to convert the plurality of Bluetooth control signals received by the first Bluetooth communication module 212 to the infrared control signals of the first infrared communication module 213. The first infrared communication module 212 is configured to send the infrared control signals to the first infrared home appliance control module 111 of the first home appliance 11 by using the first infrared communication protocol.

Compared to the first infrared signal receiving terminal (not shown in the drawings) of the first infrared home appliance control module 111 having the first signal receiving range, the first infrared communication module 213 of the first control device 21 has a first signal transmitting range. The first infrared home appliance control module 111 is disposed within the first signal transmitting range of the first infrared communication module 213 of the first control device 21, and there is no signal shielding between the first control device 21 and the first infrared home appliance control module 111.

In the embodiment, the second control device 22 includes a second control module 221, a second Bluetooth communication module 222, and a second infrared communication module 223.

The second Bluetooth communication module 222 is configured to receive a plurality of Bluetooth control signals. The second infrared communication module 223 is configured to send a plurality of infrared control signals. The second control module 221 is electrically connected to the second Bluetooth communication module 222 and the second infrared communication module 223. The second control module 221 is configured to convert the plurality of Bluetooth control signals received by the second Bluetooth communication module 222 to the infrared control signals of the second infrared communication module 223. The second infrared communication module 222 is configured to send the infrared control signals to the second infrared home appliance control module 121 of the second home appliance 12 by using the second infrared communication protocol.

Compared to the second infrared signal receiving terminal (not shown in the drawings) of the second infrared home appliance control module 121 having the second signal receiving range, the second infrared communication module 223 of the second control device 22 has a second signal transmitting range. The second infrared home appliance control module 121 is disposed within the second signal transmitting range of the second infrared communication module 223 of the second control device 22, and there is no signal shielding between the second control device 22 and the second infrared home appliance control module 121.

In the embodiment, the third control device 23 includes a third control module 231, a third Bluetooth communication module 232, and a third infrared communication module 233.

The third Bluetooth communication module 232 is configured to receive a plurality of Bluetooth control signals. The third infrared communication module 233 is configured to send a plurality of infrared control signals. The third control module 231 is electrically connected to the third Bluetooth communication module 232 and the third infrared communication module 233. The third control module 231 is configured to convert the plurality of Bluetooth control signals received by the third Bluetooth communication module 232 to the infrared control signals of the third infrared communication module 233. The third infrared communication module 232 is configured to send the infrared control signals to the third infrared home appliance control module 131 of the third home appliance 13 by using the third infrared communication protocol.

Compared to the third infrared signal receiving terminal (not shown in the drawings) of the third infrared home appliance control module 131 having the third signal receiving range, the third infrared communication module 233 of the third control device 23 has a third signal transmitting range. The third infrared home appliance control module 131 is disposed within the third signal transmitting range of the third infrared communication module 233 of the third control device 23, and there is no signal shielding between the third control device 23 and the third infrared home appliance control module 131.

In the embodiment, the mobile control device 50 of the home appliance control system 1 is configured to send a plurality of control signals of the first home appliance 11, the second home appliance 12, or the third home appliance 13 to the server 30. The server 30 sends the Bluetooth control signal corresponding to the control signal to the control device corresponding to the home appliance selected by the user according to the control signal transmitted by the mobile control device 50 and an identification number corresponding to the first home appliance 11, the second home appliance 12, or the third home appliance 13 in the control signal.

That is to say, the server 30 send the Bluetooth control signal corresponding to the control signal to the first control device 21 of the first home appliance 11, the second control device 22 of the second home appliance 12, or the third control device 23 of the third home appliance 13 according to the control signal of the mobile control device 50.

When one of the first Bluetooth communication module 212 of the first control device 21, the second Bluetooth communication module 222 of the second control device 22, and the third Bluetooth communication module 232 of the third control device 23 receives the Bluetooth control signal, one of the first infrared communication module 213 of the first control device 21, the second infrared communication module 223 of the second control device 22, and the third infrared communication module 233 of the third control device 23 correspondingly sends the infrared home appliance control signal to one of the first infrared home appliance control module 111 of the first home appliance 11, the second infrared home appliance control module 121 of the second home appliance 12, or the third infrared home appliance control module 131 of the third home appliance 13.

The mobile control device 50 includes a smart phone, a mobile tablet, and a smart watch. The user can selects one of the first home appliance 11, the second home appliance 12, and the third home appliance 13 through a program of the mobile control device 50 to further adjust functions.

In addition, the first control device 21 includes a first power supply module (not shown in the drawings), the second control device 22 includes a second power supply module (not shown in the drawings), and the third control device 23 includes a third power supply module (not shown in the drawings). The first power supply module, the second power supply module, and the third power supply module include a button battery, a lithium battery, a AC-to-DC voltage converter, or a DC-to-DC voltage converter, respectively.

In the embodiment, a communication protocol between the mobile control device 50 and the server 30 can be a Bluetooth communication protocol 4.0, a Bluetooth communication protocol 5.0, a Wireless Fidelity communication protocol (Wi-Fi), a LoRa communication protocol, a Sigfox communication protocol, a fourth generation mobile communication technique communication protocol (4G), or a fifth generation mobile communication technique communication protocol (5G), and be adjusted and designed according to demands, and the present disclosure is not limited therein.

A communication protocol between the server 30 and the first control device 21, the second control device 22, and the third control device 23 can be the Bluetooth communication protocol 4.0, or the Bluetooth communication protocol 5.0. In addition, the first Bluetooth communication module 212, the second Bluetooth communication module 222, and the third Bluetooth communication module 232 are a low power Bluetooth communication module.

In the embodiment, the number of home appliances and the number of control devices can be adjusted and designed according to demands, and the present disclosure is not limited therein. In the embodiment, the server 30 is disposed in the predefined area H. In other embodiments, the server can be disposed in other areas, such as a cloud server, and the present disclosure is not limited therein.

In summary, in the present disclosure, with a control device, which combines an infrared transmission function and a Bluetooth communication function, disposed on each home appliance, the issue that the infrared transmission will be shielded by obstructions can be solved. Further, with the Bluetooth communication function, the home appliance can be controlled locally or outdoors, so that the installation cost can be significantly reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A home appliance control system, comprising:
a first control device disposed on a first home appliance, wherein the first home appliance includes a first infrared home appliance control module having a first infrared communication protocol, the first control device including:
a first Bluetooth communication module configured to receive a plurality of Bluetooth control signals;
a first infrared communication module configured to send a plurality of infrared control signals; and
a first control module electrically connected to the first Bluetooth communication module and the first infrared communication module, and configured to convert the plurality of Bluetooth control signals received by the first Bluetooth communication module to the infrared control signals of the first infrared communication module, wherein the first infrared communication module is configured to send the infrared control signals to the first infrared home appliance control module of the first home appliance by using the first infrared communication protocol; and
a second control device disposed on a second home appliance, wherein the second home appliance includes a second infrared home appliance control module having a second infrared communication protocol, the second control device including:
a second Bluetooth communication module configured to receive a plurality of Bluetooth control signals;
a second infrared communication module configured to send a plurality of infrared control signals;
a second control module electrically connected to the second Bluetooth communication module and the second infrared communication module, and configured to convert the plurality of Bluetooth control signals received by the second Bluetooth communication module to the infrared control signals of the second infrared communication module, wherein the second infrared communication module is configured to send the infrared control signals to a second infrared home appliance control module of the second home appliance by using a second infrared communication protocol;
a mobile control device; and
a server, the mobile control device communicating to the server, the mobile control device sending a plurality of control signals to the server, and the server sending a plurality of home appliance control signals of the first home appliance or the second home appliance corresponding to the plurality of control signals to the first control device or the second control device for controlling the first home appliance or the second home appliance.

2. (canceled)

3. The home appliance control system according to claim 1, wherein the mobile control device includes a smart phone, a mobile tablet, and a smart watch.

4. The home appliance control system according to claim 1, wherein the first infrared home appliance control module is disposed within a first signal transmission range of the first infrared communication module of the first control device, and the second infrared home appliance control module is disposed within a second signal transmission range of the second infrared communication module of the second control device.

5. The home appliance control system according to claim 1, wherein the first control device further includes a first power supply module, and the second control device further includes a second power supply module.

6. The home appliance control system according to claim 5, wherein the first power supply module and the second power supply module include a button battery, a lithium battery, an AC-to-DC voltage converter, or a DC-to-DC voltage converter respectively.

7. The home appliance control system according to claim 1, wherein the mobile control device communicates with the first control device and the second control device by a Bluetooth communication protocol 4.0 or a Bluetooth communication protocol 5.0.

8. The home appliance control system according to claim 1, wherein the first Bluetooth communication module and the second Bluetooth communication module are a low power Bluetooth communication module.
